(19) United States
(12) Patent Application Publication
(10) Pub. No.: US 2018/0248328 A1
(43) Pub. Date: Aug. 30, 2018

(54) DISK BLANK FOR PRODUCING COMMUTATOR BARS

(71) Applicant: SCHUNK CARBON TECHNOLOGY GMBH, Bad Goisem (AT)

(72) Inventors: Martin Maurer, Ebensee (AT); Florian Huber, Bad Ischl (AT)

(21) Appl. No.: 15/755,152

(22) PCT Filed: Aug. 19, 2016
(86) PCT No.: PCT/EP2016/069706

§ 371 Date: Feb. 26, 2018

(30) Foreign Application Priority Data
Sep. 2, 2015 (EP) 15183488.4

(51) Int. Cl. H01R 43/08; H01R 39/04; H01R 39/06; H02K 13/00

(52) U.S. Cl. CPC H01R 43/08; H01R 39/045; F02M 37/08; H02K 13/006; H01R 39/06

(57) ABSTRACT

The invention relates to a disk blank (18) for producing commutator bars of a disk commutator as well as to a commutator bar and a disk commutator realized as having such commutator bars, said disk blank (18) being realized as a multi-layered body and having a carbon mold body having a continuous first layer and having a contact arrangement which forms a second layer disrupted by transition areas in such a manner that the transition areas do not comprise any contact material.

The present invention relates to a disk blank for producing commutator bars of a disk commutator, comprising a carbon mold body made of a carbon material for forming tread segments of the commutator bars and a contact arrangement made of a carbon and arranged on the carbon mold body and a contact material comprising a contact metal for forming connecting segments of the commutator bars.

Disk commutators are used in particular in fuel pumps for the electromotor drives of the fuel pumps, said disk commutators being assembled from commutator bars which comprise tread segments free of copper. By doing so, it is to be ensured that copper particles cannot be released due to abrasion of the commutator bars while operating the fuel pumps, said copper particles otherwise possibly causing electro-erosive processes between the carbon brushes and the commutator bars of the fuel pump.

Generally, the disk commutators assembled from commutator bars are produced based on disk blanks, which are formed annularly and are produced in a compression molding method based on a homogenized mixture of carbon-based powders, such as graphite or coke, and organic binding agents, such as resin or polymers. Before the commutator bars are separated from the disk blank, a contact layer made of a metallic material, preferably copper, is applied to the disk blank so that the commutator bars each comprise a layer made of carbon material for forming the tread segment and a layer of the metallic contact material formed thereon as a connecting segment after the separation, said connecting segment enabling electrically contacting the tread segments to the winding of the electric motor.

In the known disk commutators or rather in the commutator bars made from the disk blanks, copper particles released via the cutting or sawing process are accumulated at the cutting edges formed via separation due to the previously described assembly of the disk blanks, in which the contact material for forming the connecting segments as a contact layer extends across the entire surface of the carbon mold body, said copper particles possibly leading to an increased wear between the carbon brushes and the commutator bars as well as to a negative impact on the substances in the fuel during operation.

Furthermore, it has proven that thermally induced mechanical tensions arise between the tread segment and the contact layer during operation of the disk commutator in the known commutator bars, which are produced according to the two-phase production method described above and in which therefore the contact material layer is applied to the disk blank after the disk blank has been produced, said mechanical tensions being able to lead to delaminations between the tread segment and the contact layer and thus to the fuel pump failing.

The object of the present invention is to propose a disk blank which enables producing safe-to-operate commutator bars.

In order to attain this object, the disk blank according to the invention comprises the features of claim 1.

The disk blank according to the invention comprises a contact arrangement made of contact bodies distanced from one another via transition areas on the carbon mold body formed from the carbon material, said contact bodies being realized as contact-material mold bodies and being connected to the carbon mold body in a compression molding method in such a manner that the disk blank is realized as a multi-layer body, said carbon mold body forming a continuous first layer and said contact arrangement forming a second layer disrupted by the transition areas in such a manner that the transition areas do not comprise contact material.

The disk blank realized according to the invention enables, on the one hand, forming a composite between the contact arrangement and the carbon mold body simultaneously to producing the carbon mold body and the contact arrangement due to being realized as a multi-layer body produced in a compression molding method. On the other hand, it is possible to separate the commutator bars from the disk blank following the compression molding method using a separating cut in an area of the contact disk blank free of contact material and formed between the contact bodies due to the contact arrangement being made of contact bodies distanced to one another so that no contact metal contained in the contact material is exposed via the separating cut and cannot be present as free particles at the cutting edge.

Preferably, the transition areas form gaps between the contact bodies or the transition areas comprise a separating material between the contact bodies.

In a particularly preferred embodiment of the disk blank, the disk blank comprises a transition zone between the carbon mold body and the contact bodies, said transition zone comprising the carbon material of the carbon mold body as well as the contact material of the contact bodies so that a particularly secure mechanical composite is enabled between the carbon mold body and the contact bodies having a transition, which is continuously formed due to the material mixing in the transition zone, from the thermic expansion coefficient of the carbon material to the thermal expansion coefficient of the contact material deviating therefrom and thus arising tensions, which can lead to delaminations, can be particularly effectively counteracted.

If the contact bodies are realized as multi-layer bodies made of at least two contact layers, which comprise an inner contact layer for forming a contact body base and an outer contact layer arranged on the inner contact layer for forming a contact-body upper part, the thermal expansion coefficient in the contact body itself can be continuously differentiated as well as an electrical conductibility advantageously maximized in the contact-body upper part can be undertaken for a particularly secure contact between the commutator bars and a winding of the electric motor.

Preferably in this context, the contact material of the contact-body upper part comprises a higher percentage by weight of a contact metal than the contact material of the contact body base.

In order to attain a particularly safe operation of the commutator bars made from the disk blank, it is advantageous if the contact material of the contact body base comprises a higher percentage by weight of carbon than the contact material of the contact-body upper part.

Preferably, the contact material comprises copper or a copper alloy or silver or a silver alloy as a contact metal.

In particular in regard of an increased contact safety between the contact-body upper parts of the commutator bars made from the disk blank and the winding of the motor, it is advantageous if the contact material of the contact-body upper part and the contact material of the contact body base comprise different contact metals.

The commutator bar according to the invention comprises the features of claim 9.

In a preferred embodiment, the contact body comprises a smaller extension in the tread direction of the disk commutator than the tread segment so that body edges of the contact body extending transversally to the tread direction are offset to the back with respect to cutting edges of the tread segment, and the tread segment comprises a tread protrusion protruding from the contact body.

According to claim 11, the disk commutator according to the invention comprises an annular arrangement of the commutator bars arranged on a carrier body.

In the following, preferred embodiments of the disk blank are further described by means of the drawings.

In the drawings,

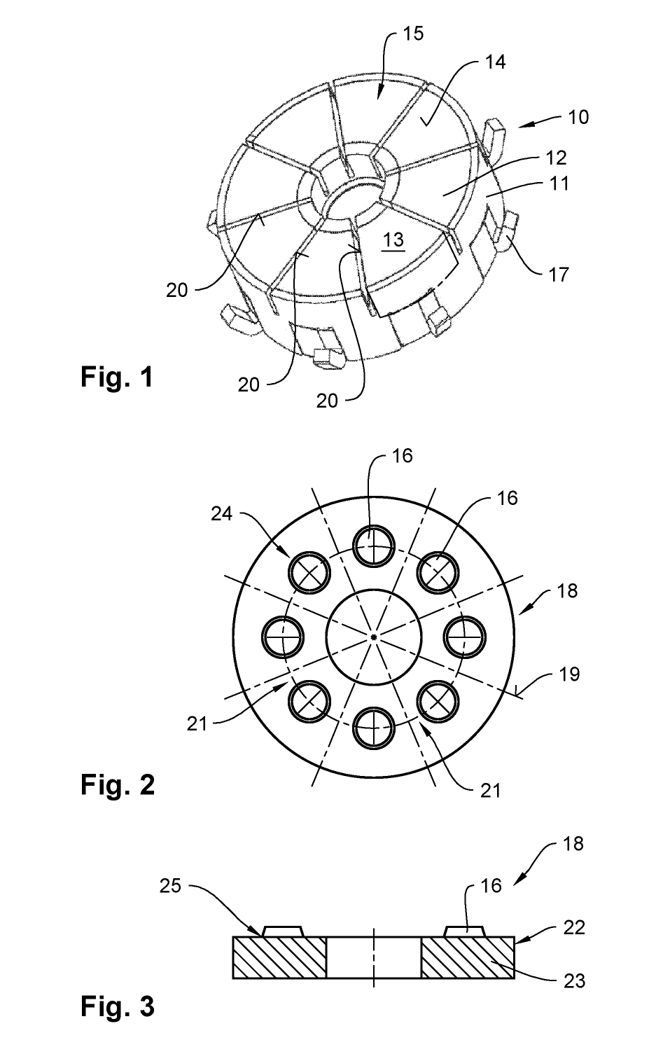

FIG. 1 illustrates a disk commutator having a plurality of commutator bars arranged on a carrier body in an isometric view;

FIG. 2 illustrates a disk blank for producing the commutator bars illustrated in FIG. 1 in a bottom view;

FIG. 3 illustrates the disk blank illustrated in FIG. 2 in a cross-sectional view;

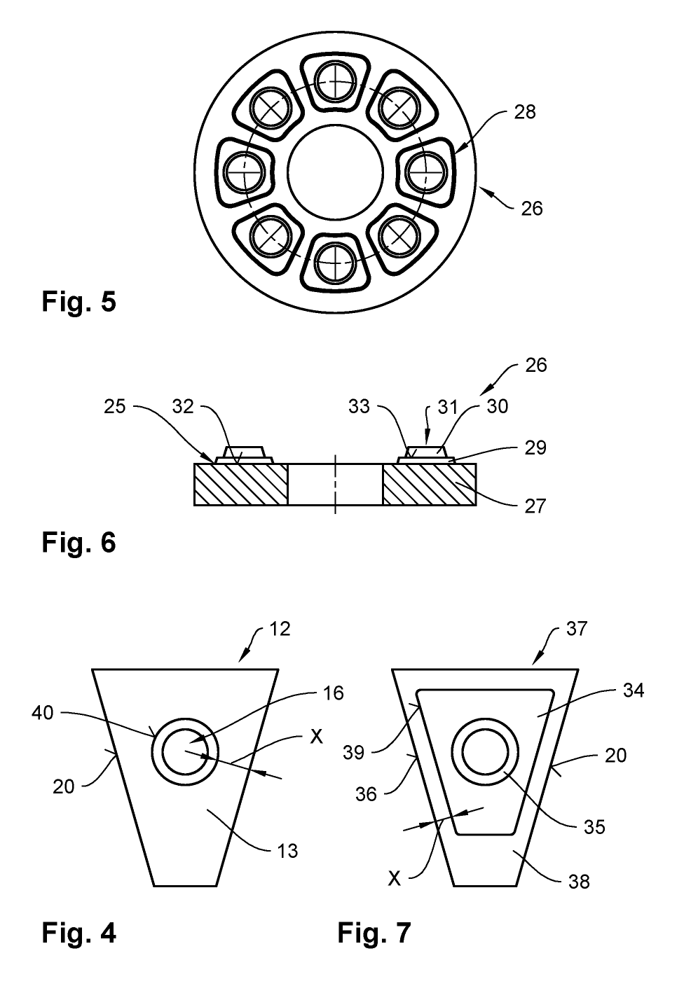

FIG. 4 illustrates a commutator bar separated from the disk blank illustrated in FIGS. 2 and 3;

FIG. 5 illustrates another embodiment of a disk blank in a bottom view;

FIG. 6 illustrates the disk blank illustrated in FIG. 5 in a cross-sectional view;

FIG. 7 illustrates a commutator bar separated from the disk blank illustrated in FIGS. 5 and 6.

FIG. 1 illustrates a disk commutator 10 having a carrier body 11, which is made of non-conductive plastic and which comprises eight commutator bars 12 in the example of the illustrated embodiment, said commutator bars 12 each being arranged such on the carrier body 11 that the tread segments 13 of the commutator bars 12 are arranged in a shared contact plane 15 of the disk commutator 10 with their contact surfaces 14 and can be contacted to carbon brushes not illustrated in this instance in this contact plane 15.

As can be seen in FIG. 4, which illustrates a commutator bar in a bottom view, the commutator bars 12 each comprise a contact body 16 on an underside of the tread segments 13, said contact body 16 forming a connecting segment of the commutator bar 12 and being contacted to hook-shaped outer contacts 17 illustrated in FIG. 1, which serve for contacting or receiving, respectively, a winding of an electric motor.

In FIGS. 2 and 3, a disk blank 18 is illustrated, which serves for producing the commutator bars 12 illustrated in FIGS. 1 and 4 by separating the commutator bars 12 from the disk blank 18. As indicated by separation lines 19 in FIG. 2, radial separating cuts are carried out through the disk blank 18 for separating the commutator bars 12 so that the cutting edges 20 illustrated in FIGS. 1 and 4 are formed at the commutator bars 12.

As can be further seen in FIG. 2, the contact bodies 16 are distanced to one another along the circumference of the disk blank 18 so that transition areas 21 forming gaps in this instance are formed between the contact bodies 16, the thickness of the disk blank 18 (FIG. 3) corresponding to the thickness of the cross section of a carbon body 22 in said transition areas 21 so that a cutting surface 23 corresponds to the cross-sectional surface of the carbon mold body 22 when carrying out a separating cut along a cutting line 19 falling in the transition area 21. The contact bodies 16 remain intact when carrying out the separating cut so that no particles of a contact material forming the contact body 16 can be released.

The disk blank 18 illustrated in FIG. 3 in a cross-sectional view is realized as a multi-layer body, the carbon mold body 22 forming the first layer and a contact arrangement 24 (FIG. 2) formed from the contact bodies 16 forming a second layer in the illustration according to FIG. 3. The disk blank 18 is produced in a compression molding method, in which the carbon mold body 22 and the contact arrangement 24 assembled from the contact bodies 16 and formed on the carbon mold body 22 are produced simultaneously. This can be realized such, for example, that the carbon material, which is used for producing the carbon mold body 22 and which consists of a mixture of graphite powder and an organic binding agent, is added to a form and the carbon mold body 22 is subsequently pre-compressed. After, the contact material is applied to the surface of the pre-compressed carbon mold body 22 in a defined manner via a mold die in order to form the contact body 16. Other than a contact metal, such as copper, the contact material comprises a portion of graphite so that graphite is present not only in the carbon material for forming the carbon mold body 22 but also in the contact material for forming the contact body 16.

For producing the contact body, a contact material composition made up of 60% copper powder, 30% graphite and 10% organic binding agent, for example, has proven to be successful.

For producing the carbon mold body 22, a carbon material composition made up of 80% copper powder, 15% graphite and 5% organic binding agent has proven to be advantageous.

In FIGS. 5 and 6, a disk blank 26 is illustrated which, as can be gathered in particular from FIG. 6, comprises a three-layered assembly, which comprises a first layer formed as a carbon mold body 27 and which is provided with a double-layered contact arrangement 28. The carbon mold body 27 is realized in accordance with the carbon mold body 22 of the disk blank 18 in the instance of the present exemplary embodiment. The contact arrangement 28 comprises a contact material layer 29 abutting directly against the carbon mold body 27 and an upper contact material layer 30 formed thereon, said contact material layers 29 and 30 each forming contact bodies 31 together.

The contact material layers 29 and 30 comprise different contact-material compositions, the contact material layer 29 comprising 60% copper powder, 30% graphite and 10% of an organic binding agent in the present instance; the contact material layer 30 comprises a composition of 95% copper powder and 5% graphite, a binding agent not being necessary in this instance due to the high amount of copper.

In accordance with the disk blank 18 illustrated in FIGS. 2 and 3, the disk blank 26 illustrated in FIGS. 5 and 6 is also produced in a compression molding method, in which transition zones 32 and 33 are formed between the carbon material of the carbon mold body 27 and the adjacent contact material layer 29 as well as between the contact material layer 29 and the contact material layer 30, the layer material adjacent to each other being mixed in said transition zones 32 and 33.

As can be particularly gathered from FIG. 5, the contact material layers 29, 30 comprise outer contours deviating from one another so that the contact bodies 31 are formed in a tiered manner having a contact body base 34 formed via the contact material layer 29 and having a contact-body upper part 35, which is truncated in form in the present instance.

The truncated embodiment of the contact-body upper part 35 enables a form-fitting adjustment of the contact body 31 to an outer contact 17 of a disk commutator.

As in particular FIG. 7 illustrates, the nearly trapezoid embodiment of the contact body base 34 when seen from above enables a mostly large-surfaced coverage between the tread segments 38 and the connecting segment formed via the contact body 31 despite retaining a tread protrusion x between a body edge 39 of the contact body 31 and a cutting edge 36 of the commutator bar 37, with which the tread segment 38 protrudes from the contact body base 34. FIG. 4 accordingly illustrates a tread protrusion x between a body edge 40 of the contact body 16 and the cutting edge 20 of the commutator bar 12.

1. A disk blank (18, 26) for producing commutator bars (12, 37) of a disk commutator (10), comprising a carbon mold body (22, 27) made of carbon material for forming tread segments (13, 38) of the commutator bars and comprising a contact arrangement (24, 28) made of a carbon and arranged on the carbon mold body (22, 27) and comprising a contact material having contact metal for forming connecting segments of the commutator bars,
characterized in that
the contact arrangement comprises contact bodies (16, 31) spaced apart from each other via transition areas (21), said contact bodies (16, 31) being realized as contact-material mold bodies and being connected to the carbon mold body (22, 27) in a compression molding method in such a manner that the disk blank (18, 26) is realized as a multi-layered body, said carbon mold body (22, 27) forming a continuous first layer and said contact arrangement forming a second layer disrupted by the transition areas in such a manner that the transition areas do not comprise any contact material.

2. The disk blank according to claim 1,
characterized in that
the transition areas (21) form gaps between the contact bodies (16, 31).

3. The disk blank according to claim 1,
characterized in that
the transition areas (21) comprise a separating material between the contact bodies (16, 31).

4. The disk blank according to claim 1,
characterized in that
the carbon mold body (22, 27) and the contact bodies (16, 31) arranged on the carbon mold body are produced simultaneously in a compression molding method in such a manner that a transition zone (25) is formed between the carbon mold body and the contact bodies, said transition zone (25) comprising the carbon material of the carbon mold body as well as the contact material of the contact body.

5. The disk blank according to claim 1,
characterized in that
the contact bodies (31) are formed as multi-layered bodies made of at least two contact layers, comprising an inner contact layer for forming a contact body base (34) and an outer contact layer arranged on the inner contact layer for forming a contact-body upper part (35).

6. The disk blank according to claim 5,
characterized in that
the contact material of the contact-body upper part (35) comprises a higher percentage of weight of a contact metal than the contact material of the contact body base (34).

7. The disk blank according to claim 5,
characterized in that
the contact material of the contact body base (34) comprises a higher percentage by weight of carbon than the contact material of the contact-body upper part (35).

8. The disk blank according to claim 1,
characterized in that
the contact material comprises copper or a copper alloy as a contact metal.

9. The disk blank according to claim 1,
characterized in that
the contact material comprises silver or a silver alloy as a contact metal.

10. The disk blank according to claim 5,
characterized in that
the contact material of the contact-body upper part and the contact material of the contact body base comprise different contact metals.

11. Commutator bars for forming a disk commutator,
characterized in that
the commutator bars are produced via separation from a disk blank according to claim 1.

12. Commutator bars according to claim 11,
characterized in that
the contact body (16, 31) comprises a smaller extension in the tread direction of the disk commutator than the tread segment (13, 38) in such a manner that body edges (39, 40) of the contact body extending transversely to the tread direction are offset to the back with respect to cutting edges (20, 36) of the tread segments (13, 38), and in that the tread segment (13, 38) comprises a tread protrusion x protruding over the contact body.

13. A disk commutator for a fuel pump,
characterized in that
the disk commutator (10) comprises an annular arrangement of commutator bars (12, 37) according to claim 9, said annular arrangement being arranged on a carrier body (11).
